(19) United States
(12) Patent Application Publication
(10) Pub. No.: US 2019/0350246 A1
(43) Pub. Date: Nov. 21, 2019

(54) KINETIC FRUIT AND VEGGIE TURBO WASH

(71) Applicant: Andrew Howard Greene, Hollywood, FL (US)

(72) Inventor: Andrew Howard Greene, Hollywood, FL (US)

(21) Appl. No.: 16/354,867

(22) Filed: Mar. 15, 2019

Related U.S. Application Data
(60) Provisional application No. 62/762,808, filed on May 21, 2018.

(51) Int. Cl. A23N 12/02; A47J 43/24

(52) U.S. Cl. CPC A23N 12/02; A47L 2601/03; A47L 2601/16; A47J 43/24

(57) ABSTRACT

An apparatus for effectively washing a wide variety of smaller fruits and vegetables which can be conveniently used as a household kitchen appliance. The washing apparatus is comprised of a washing chamber or bowl with fluted or channeled interior sides, anti-skid pads on the bottom, a central axis agitator, a lid with incorporated strainer port and a geared manual crank handle. The crank handle has a gear ratio of approximately 6:1 which, under typical or normal rotation, will produce approximately 200 revolutions per minute (RPM's) across the diameter of the agitator. The agitator is designed to create the maximum amount of water uplift and central and circumferential water flow. The agitator design incorporates a semi-rigid plastic material and modified leading edges to reduce and eliminate damage and bruising to food items.

### BACKGROUND OF THE INVENTION

Fresh fruit and vegetables often contain on the surface contaminates such as insects and insect droppings, fertilizer, insect sprays, produce enhancers, dirt and sand as well as other unknown contaminants. These contaminants may be visible or unseen, and often appear as residue on fresh produce purchased from supermarkets, fresh produce stands and farmer's markets. We have all seen the warning labels on produce containers “Wash Thoroughly Before Use”

Other cleaning appliances on the market or where patents have been filed either do not perform sufficiently are too complicated and inconvenient to use. The present practice is to remove contaminants by soaking, rinsing under a faucet, using a sink sprayer and/or scrubbing raw fruits and vegetables using unfiltered or unpurified municipal or well water. This practice is unsatisfactory for a complete cleaning, is time consuming, does not conserve water resources, and does not effectively or efficiently remove impurities and surface contaminants. Additional contaminants may exist beneath the wax coatings of some fruits and vegetables.

### SUMMARY OF INVENTION

The primary object of this invention is to provide an inexpensive and effective device for cleaning and washing a wide variety small fruits and vegetables and other food items. Another important object of this invention is to provide a means of cleaning and washing delicate fruit and vegetables without damaging or degrading the food items.

A further object of the device is to facilitate an easy method of introducing and removing food items, a simple manual crank handle to drive the agitator thereby creating a turbulent and kinetic cleaning action.

The present practice is to remove contaminants by soaking, rinsing under a faucet, using a sink sprayer and/or scrubbing raw fruits and vegetables using unfiltered or unpurified municipal or well water. This practice is unsatisfactory for a complete cleaning, is time consuming, does not conserve water resources, and does not effectively or efficiently remove impurities and surface contaminants. Additional contaminants may exist beneath the wax coatings of some fruits and vegetables.

The Kinetic Fruit and Veggie Turbo Wash performs a cleaning function based on two principles: Kinetic energy and turbulence. This type of cleaning action avoids damaging delicate fruit yet provides a thorough cleaning unlike soaking or spraying with kitchen sink sprayers.

The appliance consists of a transparent canister with an incorporated strainer port on the lid, a central axis silicone rubber coated agitator, and a lid with a geared manual crank handle.

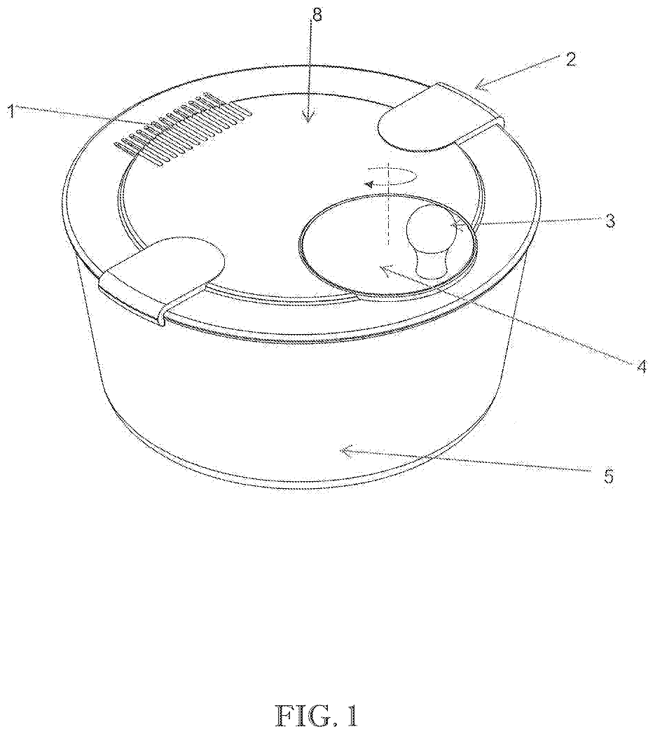

Illustration FIG. 1 Depicts top view of snap in place appliance lid, geared agitator crank handle, bowl, built in strainer port, and lid securing clips.

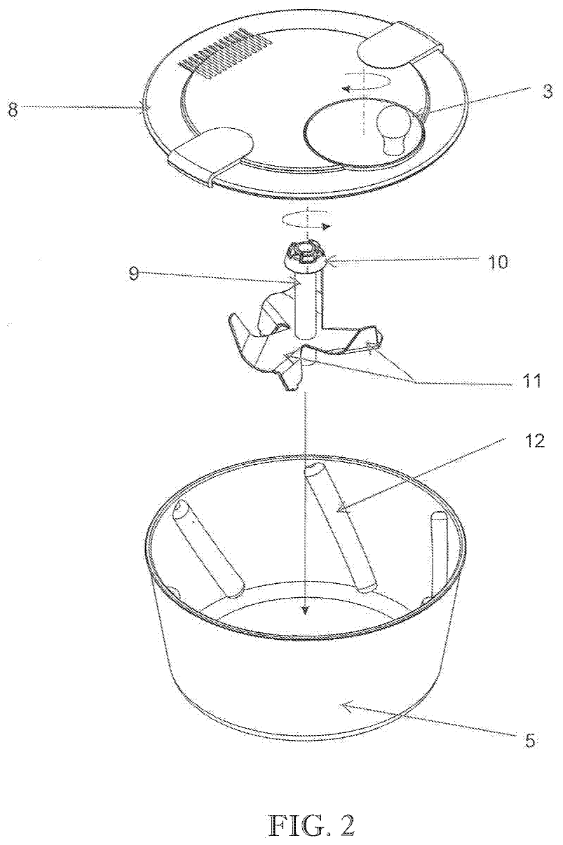

Illustration FIG. 2 Depicts exploded view of geared hand crank which is an integral part of appliance lid, central axis agitator, bowl or washing chamber with offset interior fins or channels.

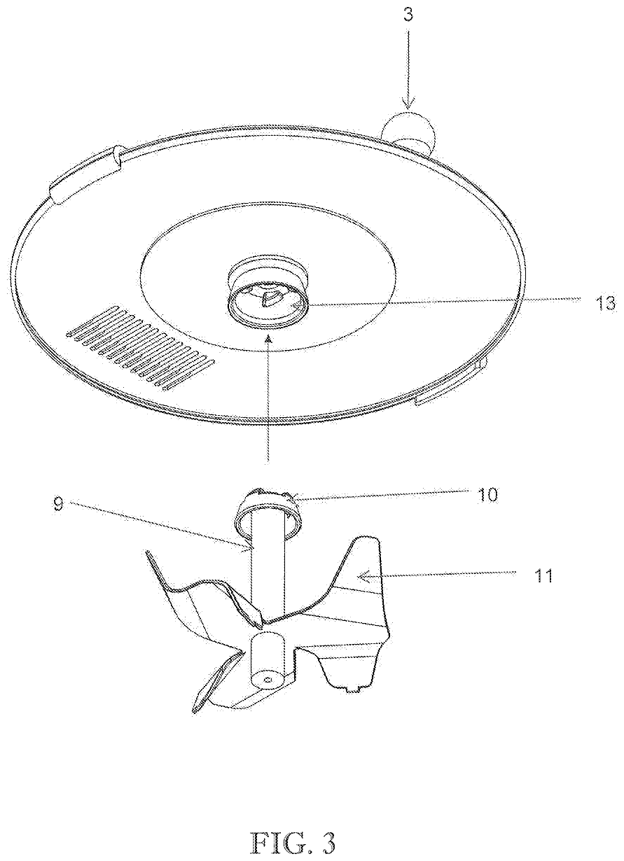

Illustration FIG. 3 Depicts overview of integrated female connector, incorporated male agitator.

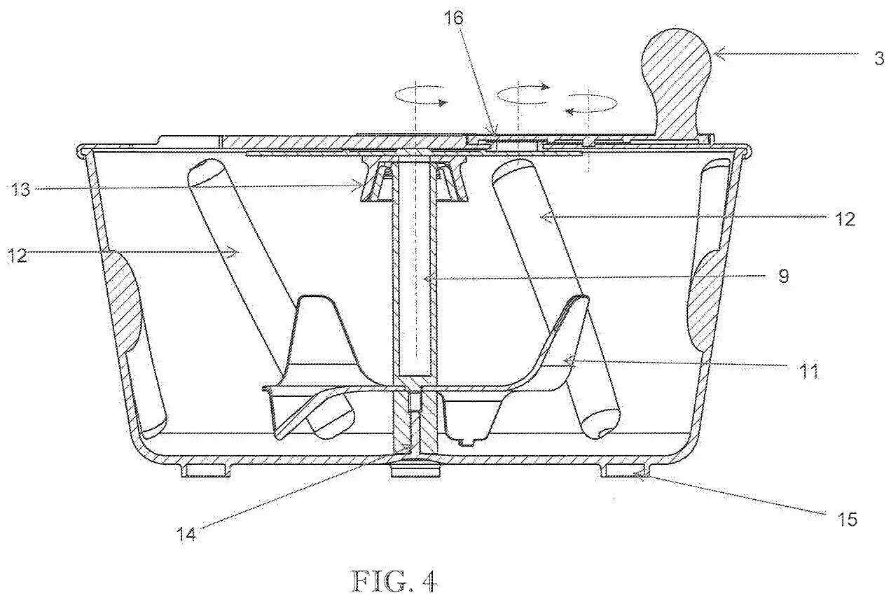

illustration FIG. 4 Depicts cross-section of fully assembled appliance with lid in place, rotating 3 blade agitator, bowl or washing chamber with offset fins or channels, crank handle, gear assembly housing 2 gears, large primary main gear and small secondary shaft drive gear.

### DETAILED DESCRIPTION AND BEST MODE OF IMPLEMENTATION

The canister is filled with water, the central axis agitator is inserted over the stabilizing post and fruit and vegetables are placed in the canister. A safe commercially available fruit and vegetable wash may be added. The lid is placed atop of the canister forming a watertight seal. On the lid a geared rotating crank handle is used to rotate the agitator at approximately 200 revolutions per minute. The agitator is specifically designed to create maximum water turbulence. Intern this turbulence sends the contents in energetic motion colliding with other contents, the nonabrasive silicone coated paddles, and fluted canister walls. The cleaning action is accomplished by kinetics; contents colliding with one another, contact with the nonabrasive silicone agitator and contact with fluted or channeled canister walls, all designed to dislodge contaminants and suspend them in water which is then emptied through the strainer on the lid.

This kitchen accessory is constructed of high grade plastic and silicone rubber. The product has four main components: (1) a lid or cover with a integral geared hand crank (2) a central axis rotating agitator, (3) central axis stabilizing post and (4) a transparent fluted or channeled canister/washing chamber.

The container is filled with water to a fill line indicated on the container. The central axis agitator is inserted over the stabilizing post. The food items are placed in the washing chamber. The lid is put into place and snaps closed to create a watertight seal. When the lid is placed atop the canister it engages the central axis agitator via a inverted female geared or toothed cone. The hand crank is then rotated in a counter-clockwise direction. The geared hand crank rotates the geared central vertical axis agitator at a ratio of one hand crank turn to six turns of the vertical axis agitator; a gear ratio of 6:1. A normal rotation speed will generate approximately 200 rpms at the vertical axis agitator. The agitator is specially designed to create upward and inward water flow as well as orbiting water at the center axis resulting in maximum turbulence. This turbulence causes the contents to collide with the silicone agitator, the fluted container walls and with other moving and suspended contents. The results of this action is a Kinetic Action, a dynamic and energizing cleaning action. Once the desired amount of cleaning time is reached the water is poured out through the strainer port on the lid. Contents a given a final rinse and are ready for consumption. The components are dishwasher safe on the top rack.

### DETAILED DESCRIPTION OF THE PREFERRED EMBODIMENT

Referring now to the drawings in which like numerals designate similar and corresponding parts throughout the several views,

In FIG. 1 a strainer port #1 for emptying post wash water from washing chamber. Security clips #2 to secure lid in place atop the washing chamber. Revolving crank handle #3 facilitates the rotation of the primary main gear plate. Primary main gear drive plate #4 engages and rotates secondary drive gear increasing RPM. Onlooking view #5 of washing chamber. FIG. 2 Exploded view of main appliance parts. Lid or cover #8 incorporates gear assembly, engages agitator and prevents overflow of water during washing process. Vertical Axis Drive shaft #9 incorporates agitator paddles #11 and pressure sensitive modular connector gear #10. View of interior of washing chamber displaying offset water channeling fins #12, FIG. 3 Drive plate connector #13 engages drive shaft. FIG. 4 Depicts assembled appliance cross-section lid #8, revolving crank handle #3, water channeling tins #2, drive plate connector gear #13, drive shaft #9 with integrated agitator paddles #11 and vertical, stabilizing post #14 to facilitate drive shaft engagement with connector drive gear. Non-skip rubber pads #15 to stabilize appliance atop counter surface preventing unintended movements. Gear assembly #16 consisting of large main drive gear and smaller step-up gear.

What I claim is:

1. A kitchen appliance for the purpose of washing small fruits and vegetables using water, or water with an additive of commercially available fruit and vegetable cleaning solution(s). The kitchen appliance is comprised of the 3 main components:
a) cover or lid,
b) vertical axis 3 blade agitator
c) a transparent plastic washing chamber or bowl.

2. The invention in claim 1 is comprised of a lid or cover with strainer type vents through which post wash water is emptied without requiring removal the lid.

3. The invention in claim 1 further comprises two 180° horizontally opposed friction catches to secure lid to washing chamber or bowl.

4. The invention in claim 1 further comprises a circular rotating manual crank handle

5. The invention in 1 is further comprised of 2 gears incorporated into the body of the lid and integrally attached to the crank handle

6. The invention in 1 is further comprised of a drive connector wherein the smaller high-speed gear is directly and integrally attached.

7. The invention in claim 1 is further comprised of a hollow cylindrical central axis agitator comprised of a vertical post, 3 integral agitator blades wherein a normal counterclockwise rotation of the crank handle of approximately 60 revolutions per minute(RPM's) will produce approximately 200 rpm across the diameter of the agitator, wherein the revolving agitator produces water movement and turbulence thereby exciting the food items effectuating the cleaning process via kinetic energy (food items colliding) and dislodging contaminants.

8. The invention of claim 1 is further comprised of an agitator designed to create maximum water turbulence and uplift without damaging or degrading the food items

9. The invention in claim 1 is further comprised of integral vertical stabilizing post situated in the center of the washing chamber or bowl wherein the hollow cylindrical vertical axis agitator is placed over the stabilizing post vertically positioning the agitator to engage the drive connector via pressure sensitive toothed gear integrated atop vertical axis agitator

10. The invention in claim 1 is further comprised of transparent plastic washing chamber, wherein turbulence producing fins or vanes are an integral part of washing chamber or bowl, wherein water movement across these vanes creates water turbulence further effectuating the cleaning process and removal of surface contaminants.

11. The invention in claim 1 is further comprised of four (4) anti-skid pads incorporated into the bottom of the washing chamber providing for a stable non-slip appliance during the washing process.
